(19) United States
(12) Patent Application Publication
(10) Pub. No.: US 2025/0185096 A1
(43) Pub. Date: Jun. 5, 2025

(54) DATA TRANSMISSION METHOD AND APPARATUS, AND TERMINAL

(71) Applicant: VIVO MOBILE COMMUNICATION CO., LTD., Dongguan (CN)

(72) Inventor: Qian ZHENG, Dongguan (CN)

(21) Appl. No.: 19/044,949

(22) Filed: Feb. 4, 2025

Related U.S. Application Data
(63) Continuation of application No. PCT/CN2023/110693, filed on Aug. 2, 2023.

(30) Foreign Application Priority Data
Aug. 5, 2022 (CN) 202210938764X

(51) Int. Cl. H04W 76/15; H04W 76/14; H04W 76/18; H04W 76/27

(52) U.S. Cl. CPC H04W 76/15; H04W 76/14; H04W 76/18; H04W 76/27

(57) ABSTRACT

A data transmission method is disclosed. The method includes: transmitting, by a first terminal, data with a network-side device through a multi path, wherein the multi path comprises a direct path through which the first terminal is in directly communication with the network-side device and/or an indirect path through which the first terminal is in communication with the network-side device via a second terminal; and suspending, in a case that the first terminal detects that a first path of the multi path fails, data transmission through the first path.

### CROSS-REFERENCE TO RELATED APPLICATIONS

This application is a bypass continuation application of International Application No. PCT/CN/2023/110693, filed on Aug. 2, 2023, which claims the benefit of and priority to Chinese Patent Application No.202210938764.X, filed on Aug. 5, 2022, both of which are incorporated herein in their entirety by reference.

### TECHNICAL FIELD

The disclosure belongs to the technical field of communication and, particularly, relates to a data transmission method and apparatus, and a terminal.

### BACKGROUND

In the related art, only a single-path data transmission processing method is available between a terminal and a network-side device. For example, a direct path can be established between the terminal and the network-side device, and data transmission processing is performed after a radio link failure is determined. Alternatively, an indirect path is established between the terminal and the network-side device, and data transmission processing is performed after a radio link failure is determined.

### BRIEF SUMMARY

Embodiments of the disclosure provide a data transmission method and apparatus, and a terminal. This can reduce interruption of data reception and transmission of the terminal and maintain service continuity.

In a first aspect, a data transmission method is provided. The method includes:
transmitting, by a first terminal, data with a network-side device through a multi path, where the multi path includes a direct path through which the first terminal is in directly communication with the network-side device and/or an indirect path through which the first terminal is in communication with the network-side device via a second terminal; and
suspending, in a case that the first terminal detects that a first path of the multi path fails, data transmission through the first path.

In a second aspect, a data transmission apparatus is provided. The apparatus includes:
a transmitting module used to transmit data with a network-side device through a multi path, where the multi path includes a direct path through which the first terminal is in directly communication with the network-side device and/or an indirect path through which the first terminal is in communication with the network-side device via a second terminal; and
a processing module used to suspend, in a case that it is detected that a first path of the multi path fails, data transmission through the first path.

In a third aspect, a terminal is provided. The terminal includes a processor and a memory. The memory stores a program or an instruction capable of being run on the processor. When the program or the instruction is executed by the processor, the steps of the method as mentioned in the first aspect are implemented.

In a fourth aspect, a terminal is provided. The terminal includes a processor and a communication interface. The communication interface is used to transmit data with a network-side device through a multi path. The multi path includes a direct path through which the first terminal is directly in communication with the network-side device and/or an indirect path through which the first terminal is in communication with the network-side device via a second terminal. The processor is configured to suspend, in a case that it is detected that the first path of the multi path fails, data transmission through the first path.

In a fifth aspect, a data transmission system is provided. The system includes: a network-side device and a terminal. The terminal is used to execute the steps of the data transmission method as mentioned in the first aspect.

In a sixth aspect, a readable storage medium is provided. The readable storage medium stores a program or an instruction. When the program or the instruction is executed by a processor, the steps of the method as mentioned in the first aspect are implemented.

In a seventh aspect, a chip is provided. The chip includes a processor and a communication interface. The communication interface is coupled to the processor. The processor is configured to run a program or an instruction to implement the method as mentioned in the first aspect.

In an eighth aspect, a computer program/program product is provided. The computer program/program product is stored in a storage medium. The computer program/program product is executed by at least one processor to implement the data transmission method as mentioned in the first aspect.

### BRIEF DESCRIPTION OF THE DRAWINGS

FIG. 1 is a block diagram of an applicable radio communication system according to an embodiment of the disclosure;

FIG. 2 is a schematic diagram of a relay scenario;

FIG. 3 is a schematic diagram of an SL relay architecture;

FIG. 4 is a schematic diagram of a non-SL relay architecture;

FIG. 5 is a schematic flow diagram of a data transmission method according to an embodiment of the disclosure;

FIG. 6 is a schematic structural diagram of a data transmission apparatus according to an embodiment of the disclosure;

FIG. 7 is a schematic structural diagram of a communication device according to an embodiment of the disclosure; and

FIG. 8 is a schematic structural diagram of a terminal according to an embodiment of the disclosure.

### DETAILED DESCRIPTION

Technical solutions in embodiments of the disclosure will be clearly described below in combination with accompanying drawings in the embodiments of the disclosure. Understandably, the described embodiments are merely some embodiments rather than all embodiments of the disclosure. All other embodiments obtained by those of ordinary skill in the art based on embodiments of the disclosure all fall within the scope of protection of the disclosure.

The terms “first,” “second,” and so forth in the description and claims of the disclosure are used to distinguish between similar objects, but are not used to describe a specific sequence or order. It should be understood that terms so used can be interchanged under appropriate circumstances such that an embodiment of the disclosure can be implemented in a sequence other than those illustrated or described herein. Moreover, the objects distinguished by “first” and “second” generally belong to one type. A number of objects is not limited. For example, one or more first objects can be arranged. In addition, “and/or” in the description and claims indicates at least one of the connected objects, and the character “/” generally indicates that the associated objects are in an “or” relationship.

It should be noted that technologies described in embodiments of the disclosure are not limited to a long term evolution (Long Term Evolution, LTE)/LTE-advanced (LTE-Advanced, LTE-A) system, but can also be used for other radio communication systems, such as code division multiple access (Code Division Multiple Access, CDMA), time division multiple access (Time Division Multiple Access, TDMA), frequency division multiple access (Frequency Division Multiple Access, FDMA), orthogonal frequency division multiple access (Orthogonal Frequency Division Multiple Access, OFDMA), single-carrier frequency division multiple access (Single-carrier Frequency Division Multiple Access, SC-FDMA) and other systems. The terms “system” and “network” in embodiments of the disclosure are often interchangeably used. The described technologies may be used for systems and radio technologies mentioned above as well as for other systems and radio technologies. A new radio (New Radio, NR) system is described in the following descriptions for an illustrative purpose, and NR terms are used in most of the following descriptions. However, these technologies can also be applied to applications other than NR system applications, such as a 6th generation (6th Generation, 6G) communication system.

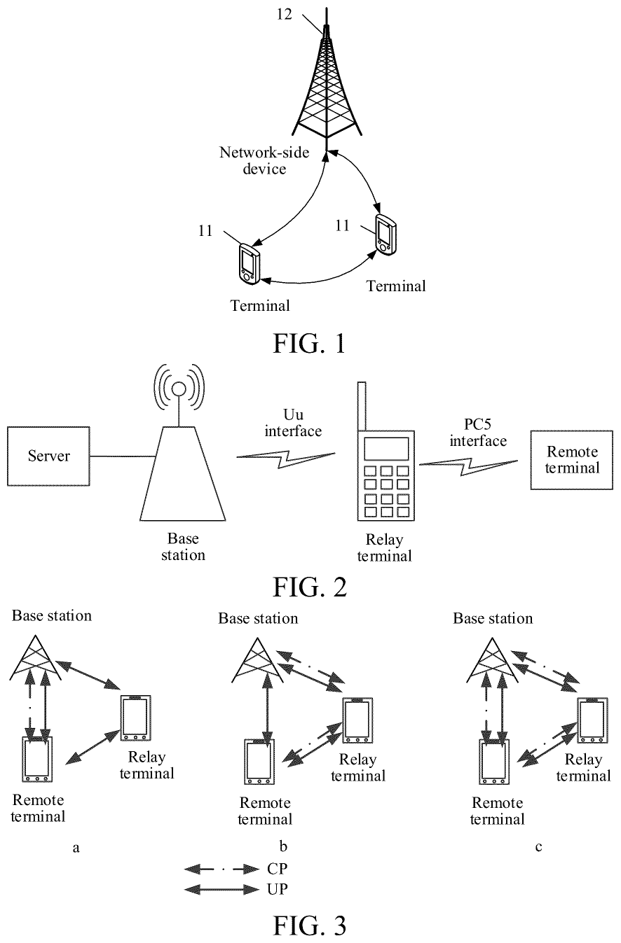

FIG. 1 shows a block diagram of an applicable radio communication system according to an embodiment of the disclosure. The radio communication system includes a terminal 11 and a network-side device 12. The terminal 11 can be a mobile phone, a tablet personal computer (Tablet Personal Computer), a laptop computer (Laptop Computer) which is also referred to as a notebook computer, a personal digital assistant (Personal Digital Assistant, PDA), a palm computer, a netbook, an ultra-mobile personal computer (ultra-mobile personal computer, UMPC), a mobile internet device (Mobile Internet Device, MID), an augmented reality (augmented reality, AR)/virtual reality (virtual reality, VR) device, a robot, a wearable device (Wearable Device), vehicle user equipment (Vehicle User Equipment, VUE), a pedestrian user equipment (Pedestrian User Equipment, PUE), and smart home (a home device having a radio communication function, such as a refrigerator, a television, a washing machine and furniture), a game console, a personal computer (personal computer, PC), a teller machine, a self-service machine, and other terminal-side devices. The wearable device includes a smart watch, a smart bracelet, a smart earphone, smart glasses, a smart jewelry (a smart bracelet, a smart hand chain, a smart ring, a smart necklace, a smart anklet, a smart foot chain, etc.), a smart wristband, smart clothing, etc. It should be noted that the specific type of the terminal 11 is not limited in embodiments of the disclosure. The network-side device 12 may include an access network device or a core network device. The access network device may alternatively be referred to as a radio access network device, a radio access network (Radio Access Network, RAN), a radio access network function, or a radio access network unit. The access network device may include a base station, a wireless local area network (Wireless Local Area Network, WLAN) access point, or a radio fidelity (Wireless Fidelity, WiFi) node, etc. The base station may be referred to as node B, evolved node B (Evolved Node B, eNB), an access point, a base transceiver station (Base Transceiver Station, BTS), a radio base station, a radio transceiver, a basic service set (Basic Service Set, BSS), an extended service set (Extended Service Set, ESS), home node B, home evolved node B, a transmitting receiving point (Transmitting Receiving Point, TRP), or another appropriate term in the field, as long as the same technical effect can be achieved. The base station is not limited to a specific technical vocabulary. It should be noted that in an embodiment of the disclosure, only a base station in an NR system is taken as an example for introduction, and the specific type of the base station is not limited.

A relay (Relay) technology in a radio communication system is used to add one or more relay nodes between the base station and the terminal. The relay nodes are responsible for forwarding a radio signal once or more. That is, the radio signal can reach the terminal after a plurality of hops.

The radio relay technology cannot only be used to expand cell coverage and make up for cell coverage blind spots, but also can improve cell capacity through spatial resource multiplexing. With regard to indoor coverage, the Relay technology can also overcome penetration loss and improve indoor coverage quality.

With a relatively simple two-hop relay as an example, a radio relay is used to divide a base-terminal link into two links, that is, a base-relay station link and a relay station-terminal link. Thus, there is an opportunity to replace a link having poor quality with two links having better quality such that higher link capacity and better coverage can be obtained.

A currently supported Relay is a UE-to-Network relay. That is, one end of the Relay is connected to UE, and the other end is connected to a network side. The UE connected to the Relay is referred to as Remote UE (Remote UE).

A typical relay scenario is shown in FIG. 2, which is a typical UE-to-Network scenario, where Remote UE is required to transmit data with a network side. However, due to poor coverage, the Relay UE is discovered to be a relay. A Uu interface is provided between the Relay UE and the base station, and a sidelink (PC5) interface is provided between the Relay UE and the Remote UE. Generally, the Relay UE is open and can serve any Remote UE.

In the related art, a radio resource control (RRC) connection establishment process of the Remote UE includes steps as follows:
Step 1: Remote UE and Relay UE execute a discovery (discovery) process and then establish a PC5 RRC connection.
Step 2: The Remote UE sends an RRC Setup Request message to the base station, and the base station replies with the RRC Setup message to the Remote UE. Specifically, the two messages are relayed by the Relay UE to the base station or the Remote UE.
Step 3: A signaling radio bearer 1 (SRB1) dedicated bearer is established between the base station and the remote UE. The SRB1 dedicated bearer of the remote UE is composed of two radio link control (RLC) channels, that is, PC5 (between the remote UE and the Relay UE) and Uu (between the Relay UE and the base station). Specifically, the two RLC channels are used for the Remote UE to transmit/receive the RRC message of the SRB1 type with the base station.
Step 4: The Remote UE sends the RRC Setup Complete message to the base station. Specifically, the message is relayed by the Relay UE to the base station.
Step 5: Security is activated between the Remote UE and the base station.
Step 6: An SRB2/data radio bearer (DRB) dedicated bearer is established between the base station and the Remote UE. The SRB2/DRB dedicated bearer of the Remote UE is composed of two RLC channels, that is, PC5 (between the Remote UE and the Relay UE) and Uu (between the Relay UE and the base station). Specifically, the two RLC channels are used for the Remote UE to transmit/receive an RRC/NAS message of the SRB2 type and uplink and downlink service data with the base station.

With respect to a sidelink relay (sidelink relay, SL relay) architecture, a multi path means that the Remote UE establishes an indirect path (indirect path) and a direct path (direct path) simultaneously, as shown in FIG. 3.

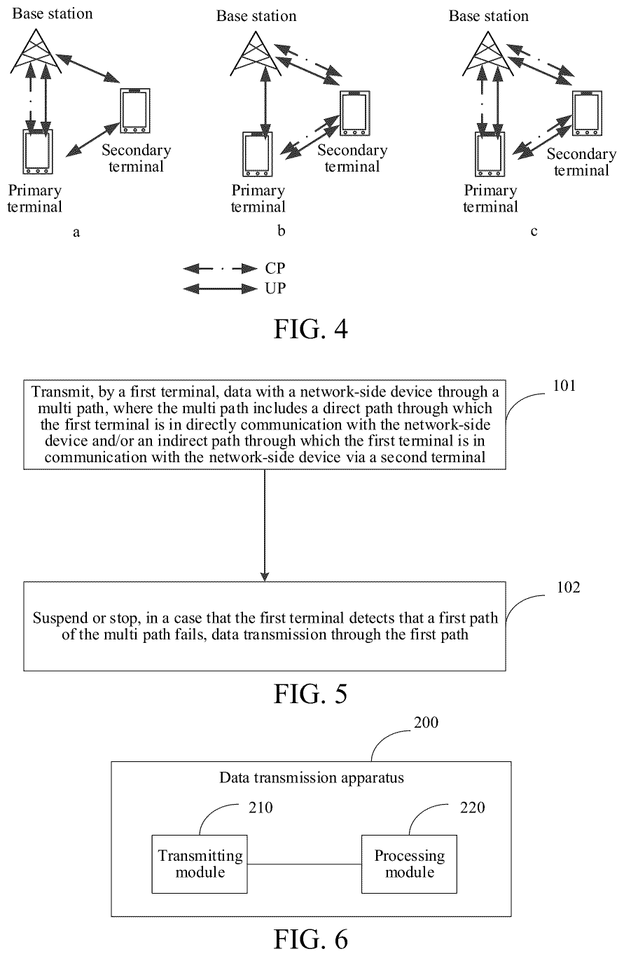

With respect to a non-SL relay architecture, the connection between two pieces of UE is not a sidelink (PC5) interface. It is assumed that the interface between the two pieces of UE is a wired connection or an ideal inter-UE connection (ideal inter-UE connection). Herein, a multi path means that one piece of UE establishes an indirect path and a direct path simultaneously, as shown in FIG. 4. Primary (Primary) UE may alternatively be referred to as anchor (Anchor) UE. Secondary (Secondary) UE may alternatively be referred to as helper (Helper) UE or aggregated (Aggregated) UE.

In the embodiment, the indirect path is translated as an indirect path, and refers to a radio link in which Remote UE (or Primary UE and Anchor UE) establishes an RRC connection with a base station through Uu air interface of Relay UE (or Secondary UE, Helper UE, and Aggregated UE) and Relay UE (or Secondary UE, Helper UE, and Aggregated UE).

The Direct path is translated as a direct path, and refers to a radio link in which Remote UE (or Primary UE and Anchor UE) establishes an RRC connection with a base station through Uu air interface of the Remote UE.

The data transmission method provided in an embodiment of the disclosure will be described in detail below in combination with accompanying drawings and through some embodiments and their application scenarios.

An embodiment of the disclosure provides a data transmission method. As shown in FIG. 5, the method includes:
Step 101: A first terminal transmits data with a network-side device through a multi path. The multi path includes a direct path through which the first terminal is in directly communication with the network-side device and/or an indirect path through which the first terminal is in communication with the network-side device via a second terminal.
Step 102: In a case that the first terminal detects that a first path of the multi path fails, data transmission through the first path is suspended or stopped.

In an embodiment of the disclosure, a multi-path connection is established between the first terminal and the network-side device. In a case that it is detected that a first path of a multi path fails, the first terminal can suspend or stop data transmission through the first path such that the terminal can temporarily suspend the data transmission in a case of a radio link failure, and resume the data transmission after a radio link restoration. That is, interruption of data reception and transmission of the terminal is reduced, and service continuity is maintained.

In the embodiment, the first terminal may be Remote UE, Primary UE, or Anchor UE. The second terminal may be Relay UE, Secondary UE, or Helper UE. A multi path (multi path) is established between the first terminal and the serving base station. User plane data and/or control plane data are transmitted between the first terminal and the serving base station through the multi path. The multi path includes at least one direct path and/or at least one indirect path. In some embodiments, the multi path may include:
at least two indirect paths; or
at least one indirect path and at least one direct path.

In some embodiments, in a case that the first path is a direct path, the step that in a case that the first terminal detects that a first path of the multi path fails, data transmission through the first path is suspended or stopped includes:
in a case that the first terminal determines that at least one of the following conditions is satisfied, the data transmission through the first path is suspended:
it is detected that a Uu air interface radio link failure occurs on the direct path;
it is detected that a Uu beam failure occurs on the direct path; and
a direct path configuration failure occurs. The direct path configuration includes an initial configuration and a reconfiguration. The initial configuration of the direct path is an addition operation on the first path. The reconfiguration of the direct path is a modification operation on the first path.

When the above situations occur, it indicates that data transmission through a direct path fails, and it is required to suspend the data transmission through the direct path. In the embodiment, in cases that it is detected that the direct path fails, and no failure is detected in the indirect path, the indirect path of the first terminal normally works. Thus, no additional processing is required for transmission through the indirect path, that is, the transmission of the indirect path can still be continuously carried out.

In some embodiments, the step that the data transmission through the first path is suspended includes at least one of the following:
suspending direct path transmission for at least one data radio bearer (Data Radio Bearer, DRB), which includes: suspending, pausing or deactivating direct path transmission for all or some of DRBs, where the DRB includes at least one of a data radio bearer of the direct path (which is referred to as a Direct DRB for short), and a direct path part of a split data radio bearer (which is referred to as a Direct part of a split DRB for short);
suspending direct path transmission for at least one signaling radio bearer (SRB), which includes: suspending, pausing or deactivating direct path transmission for all or some of SRBs, where the SRB includes at least one of a signaling radio bearer 1 of the direct path (which is referred to as a Direct SRB1 for short), a signaling radio bearer 2 of the direct path (which is referred to as a Direct SRB2 for short), a direct path part of a split signaling radio bearer 1 (which is referred to as a Direct part of a split SRB1 for short), and a direct path part of a split signaling radio bearer 2 (which is referred to as a Direct part of a split SRB2 for short);
suspending direct path transmission for at least one Uu radio link control (Radio Link Control, RLC) channel, which includes: suspending, pausing or deactivating direct path transmission for all or some of Uu RLC channels; and
resetting a medium access control (Medium Access Control, MAC) entity of the direct path.

The above “suspend” may alternatively be interpreted as “pause” or “deactivate”.

In some embodiments, in a case that a preset restoration condition is satisfied, the first terminal resumes the data transmission through the first path, which includes at least one of the following:
direct path transmission for at least one DRB is resumed, which includes: direct path transmission for all or some of DRBs is resumed, restored or activated, where the DRB includes at least one of a data radio bearer of the direct path (which is referred to as a Direct DRB for short), and a direct path part of a split data radio bearer (which is referred to as a Direct part of a split DRB for short);
direct path transmission for at least one SRB is resumed, which includes: direct path transmission for all or some of SRBs is resumed, restored or deactivated, where the SRB includes at least one of a signaling radio bearer 1 of the direct path (which is referred to as a Direct SRB1 for short), a signaling radio bearer 2 of the direct path (which is referred to as a Direct SRB2 for short), a direct path part of a split signaling radio bearer 1 (which is referred to as a Direct part of a split SRB1 for short), and a direct path part of a split signaling radio bearer 2 (which is referred to as a Direct part of a split SRB2 for short); and
direct path transmission for at least one Uu RLC channel (channel) is resumed, which includes: direct path transmission for all or some of Uu RLC channels is resumed, restored or activated.

The restoration condition includes any one of the following:
an RRC reconfiguration message sent by a serving base station is received, where the RRC reconfiguration message carries configuration information of a direct path, the direct path may be configured according to the configuration information of the direct path, and data transmission of the direct path is resumed;
an RRC reconfiguration message sent by a serving base station is successfully applied, where the RRC reconfiguration message carries configuration information of a direct path, the direct path may be configured according to the configuration information of the direct path, and data transmission of the direct path is resumed;
an RRC reconfiguration complete message is sent to the serving base station, where an RRC reconfiguration message corresponding to the RRC reconfiguration complete message carries configuration information of the direct path, the direct path may be configured according to acquired configuration information of the direct path, and data transmission through the direct path may be resumed; and
it is confirmed that an RRC reconfiguration complete message is successfully sent to the serving base station, where an RRC reconfiguration message corresponding to the RRC reconfiguration complete message carries configuration information of the direct path, and the direct path may be configured according to the acquired configuration information of the direct path, and data transmission through the direct path may be resumed.

The above “resumed” may alternatively be interpreted as “restore” or “activate (activate)”.

In the embodiment, in a scenario that the terminal supports a multi path, if a radio link failure of a direct path occurs, the terminal can suspend data transmission of the direct path, and resume the data transmission after a radio link restoration. Thus, interruption of data reception and transmission of the terminal is reduced, and service continuity is maintained.

In some embodiments, in a case that the first path is the indirect path, the step that in a case that the first terminal detects that a first path of the multi path fails, data transmission through the first path is suspended or stopped includes any one of the following:
in a case that the first terminal detects that a radio link failure between the first terminal and the second terminal occurs on the first path, the data transmission through the first path is stopped, where an interface between the first terminal and the second terminal may be a PC5 interface; and
in a case that the first terminal receives indication information of the second terminal, the data transmission through the first path is suspended, where the indication information indicates that the second terminal satisfies a preset failure condition.

When the above situations occur, it indicates that data transmission through an indirect path fails, and it is required to suspend the data transmission through the indirect path. In the embodiment, in cases that it is detected that the indirect path fails, and no failure is detected in the direct path, the direct path of the first terminal normally works. Thus, no additional processing is required for transmission through the direct path, that is, the transmission of the direct path can still be continuously carried out.

In some embodiments, the preset failure condition includes at least one of the following:
a Uu air interface radio link failure occurs on the second terminal;
an RRC connection failure of a Uu air interface radio resource control occurs on the second terminal, which includes three situations as follows: a failure of an RRC connection establishment process (for a case that the second terminal is in an RRC idle state), a failure of an RRC connection restoration process (for a case that the second terminal is in an RRC inactive state), and a rejection of an RRC connection (for a case that the second terminal is in an RRC idle state or an RRC inactive state); and
a serving cell change occurs on the second terminal, where the serving cell change includes handover (handover) and cell (re-)selection (cell (re-)selection). In a case that the second terminal is in an RRC connected state, the serving cell change may be handover. In a case that the second terminal is in a non-RRC connected state, such as an RRC idle state or an RRC inactive state, the serving cell change may be cell (re-)selection.

In some embodiments, the step that the data transmission through the first path is suspended includes at least one of the following:
indirect path transmission for at least one DRB is suspended, which includes: indirect path transmission for all or some of DRBs is suspended, paused or deactivated, where the DRB includes at least one of a data radio bearer of the indirect path (which is referred to as an Indirect DRB for short), and an indirect path part of a split data radio bearer (which is referred to as an Indirect part of a split DRB for short);
indirect path transmission for at least one SRB is suspended, which includes: indirect path transmission for all or some of SRBs is suspended, paused or deactivated, where the SRB includes at least one of a signaling radio bearer 1 of the indirect path (which is referred to as an Indirect SRB1 for short), a signaling radio bearer 2 of the indirect path (which is referred to as an Indirect SRB2 for short), an indirect path part of a split signaling radio bearer 1 (which is referred to as an Indirect part of a split SRB1 for short), and an indirect path part of a split signaling radio bearer 2 (which is referred to as an Indirect part of a split SRB2 for short); and
indirect path transmission for at least one PC5 Relay RLC channel is suspended, which includes: indirect path transmission for all or some of PC5 Relay RLC channels is suspended, paused or deactivated; and
a PC5 MAC entity corresponding to the indirect path and the second terminal is reset.

The above “suspend” may alternatively be interpreted as “paused” or “deactivate”.

In some embodiments, the step that the data transmission through the first path is stopped includes at least one of the following:
at least one sidelink SL-DRB corresponding to the indirect path and the second terminal is released;
at least one SL-SRB corresponding to the indirect path and the second terminal is released;
at least one PC5 relay RLC channel corresponding to the indirect path and the second terminal is released; and
a PC5 MAC entity corresponding to the indirect path and the second terminal is reset.

In the embodiment, in a scenario that the terminal supports a multi path, if a radio link failure of an indirect path occurs, the terminal can stop data transmission of the indirect path, and re-establish the indirect path and then resume the data transmission after a radio link restoration.

In some embodiments, after the data transmission through the first path is suspended, the method further includes:
in a case that a preset restoration condition is satisfied, the first terminal resumes the data transmission through the first path.

The step that the first terminal resumes the data transmission through the first path includes at least one of the following:
indirect path transmission for at least one DRB is resumed, which includes: indirect path transmission for all or some of DRBs is resumed, restored or activated, where the DRB includes at least one of a data radio bearer of the indirect path (which is referred to as an Indirect DRB for short), and an indirect path part of a split data radio bearer (which is referred to as an Indirect part of a split DRB for short);
indirect path transmission for at least one SRB is resumed, which includes indirect path transmission for all or some of SRBs is resumed, restored or activated, where the SRB includes at least one of a signaling radio bearer 1 of the indirect path (which is referred to as an Indirect SRB1 for short), a signaling radio bearer 2 of the indirect path (which is referred to as an Indirect SRB2 for short), an indirect path part of a split signaling radio bearer 1 (which is referred to as an Indirect part of a split SRB1 for short), and an indirect path part of a split signaling radio bearer 2 (which is referred to as an Indirect part of a split SRB2 for short); and
indirect path transmission for at least one PC5 Relay RLC channel is resumed, which includes: indirect path transmission for all or some of PC5 Relay RLC channels is resumed, restored or activated.

In some embodiments, the restoration condition includes any one of the following:
an RRC reconfiguration message sent by a serving base station is received, where the RRC reconfiguration message carries configuration information of an indirect path, the indirect path may be configured according to the configuration information of the indirect path, and data transmission of the indirect path is resumed;
an RRC reconfiguration message sent by a serving base station is successfully applied, where the RRC reconfiguration message carries configuration information of an indirect path, the indirect path may be configured according to the configuration information of the indirect path, and data transmission of the indirect path is resumed;
an RRC reconfiguration complete message is sent to the serving base station, where the an RRC reconfiguration message corresponding to the RRC reconfiguration complete message carries configuration information of the indirect path, the indirect path may be configured according to acquired configuration information of the indirect path, and data transmission through the indirect path may be resumed; and
it is confirmed that an RRC reconfiguration complete message is successfully sent to the serving base station, where an RRC reconfiguration message corresponding to the RRC reconfiguration complete message carries configuration information of the indirect path, and the indirect path may be configured according to the acquired configuration information of the indirect path, and data transmission through the indirect path may be resumed.

The above “resume” may alternatively be interpreted as “restore” or “activate”.

In the embodiment, in a scenario that the terminal supports a multi path, if a radio link failure of an indirect path occurs, the terminal can suspend data transmission of the indirect path, and resume the data transmission after a radio link restoration. Thus, interruption of data reception and transmission of the terminal is reduced, and service continuity is maintained.

An execution entity of the data transmission method provided in an embodiment of the disclosure may be a data transmission apparatus. In an embodiment of the disclosure, with an example in which a data transmission apparatus executes a data transmission method, the data transmission apparatus provided in an embodiment of the disclosure is described.

An embodiment of the disclosure provides a data transmission apparatus applied to a first terminal. As shown in FIG. 6, the data transmission apparatus 200 includes:
a transmitting module 210 used to transmit data with a network-side device through a multi path, where the multi path includes a direct path through which the first terminal is in directly communication with the network-side device and/or an indirect path through which the first terminal is in communication with the network-side device via a second terminal; and
a processing module 220 used to suspend or stop, in a case that it is detected that a first path of the multi path fails, data transmission through the first path.

In an embodiment of the disclosure, a multi-path connection is established between the first terminal and the network-side device. In a case that it is detected that a first path of a multi path fails, the first terminal can suspend or stop data transmission through the first path such that the terminal can temporarily suspend the data transmission in a case of a radio link failure, and resume the data transmission after a radio link restoration. That is, interruption of data reception and transmission of the terminal is reduced to the greatest extent.

In the embodiment, the first terminal may be Remote UE, Primary UE, or Anchor UE. The second terminal may be Relay UE, Secondary UE, or Helper UE. A multi path (multi path) is established between the first terminal and the serving base station. User plane data and/or control plane data are transmitted between the first terminal and the serving base station through the multi path. The multi path includes at least one direct path and/or at least one indirect path. In some embodiments, the multi path includes:
at least two indirect paths; or
at least one indirect path and at least one direct path.

In some embodiments, in a case that the first path is the direct path, the processing module 220 is used to suspend, in a case that it is determined that at least one of the following conditions is satisfied, data transmission of the first path:
it is detected that a Uu radio link failure occurs on the direct path;
it is detected that a Uu beam failure occurs on the direct path; and
a direct path configuration failure occurs. The direct path configuration includes an initial configuration and a reconfiguration. The initial configuration of the direct path is an addition operation on the first path. The reconfiguration of the direct path is a modification operation on the first path.

When the above situations occur, it indicates that data transmission through a direct path fails, and it is required to suspend the data transmission through the direct path. In the embodiment, in cases that it is detected that the direct path fails, and no failure is detected in the indirect path, the indirect path of the first terminal normally works. Thus, no additional processing is required for transmission through the indirect path, that is, the transmission of the indirect path can still be continuously carried out.

In some embodiments, the step that the data transmission through the first path is suspended includes at least one of the following:
direct path transmission for at least one data radio bearer DRB is suspended, which includes: direct path transmission for all or some of DRBs is suspended, paused or deactivated, where the DRB includes at least one of a data radio bearer of the direct path (which is referred to as a Direct DRB for short), and a direct path part of a split data radio bearer (which is referred to as a Direct part of a split DRB for short);
direct path transmission for at least one signaling radio bearer SRB is suspended, which includes: transmission of all or some of SRBs of the direct path is suspended, paused or deactivated, where the SRB includes at least one of a signaling radio bearer 1 of the direct path (which is referred to as a Direct SRB1 for short), a signaling radio bearer 2 of the direct path (which is referred to as a Direct SRB2 for short), a direct path part of a split signaling radio bearer 1 (which is referred to as a Direct part of a split SRB1 for short), and a direct path part of a split signaling radio bearer 2 (which is referred to as a Direct part of a split SRB2 for short); and
direct path transmission for at least one Uu radio link control RLC channel is suspended, which includes direct path transmission for all or some of Uu RLC channels is suspended, paused or deactivated; and
a medium access control MAC entity of the direct path is reset.

The above “suspend” may alternatively be interpreted as “pause” or “deactivate”.

In some embodiments, the processing module 220 is used to resume, in a case that a preset restoration condition is satisfied, the data transmission through the first path, which includes at least one of the following:
direct path transmission for at least one DRB of the direct path is resumed, which includes: direct path transmission for all or some of DRBs is resumed, restored or activated, where the DRB includes at least one of a data radio bearer of the direct path (which is referred to as a Direct DRB for short), and a direct path part of a split data radio bearer (which is referred to as a Direct part of a split DRB for short);
direct path transmission for at least one SRB is resumed, which includes: direct path transmission for all or some of SRBs is resumed, restored or deactivated, where the SRB includes at least one of a signaling radio bearer 1 of the direct path (which is referred to as a Direct SRB1 for short), a signaling radio bearer 2 of the direct path (which is referred to as a Direct SRB2 for short), a direct path part of a split signaling radio bearer 1 (which is referred to as a Direct part of a split SRB1 for short), and a direct path part of a split signaling radio bearer 2 (which is referred to as a Direct part of a split SRB2 for short); and
direct path transmission for at least one Uu RLC channel is resumed, which includes: direct path transmission for all or some of Uu RLC channels is resumed, restored or activated.

In some embodiments, the DRB includes at least one of the following:
the data radio bearer of the direct path; and
a direct path part of a split data radio bearer.

In some embodiments, the SRB includes at least one of the following:
a signaling radio bearer 1 of the direct path;
a signaling radio bearer 2 of the direct path;
a direct path part of a split signaling radio bearer 1; and
a direct path part of a split signaling radio bearer 2.

The restoration condition includes any one of the following:
an RRC reconfiguration message sent by a serving base station is received, where the RRC reconfiguration message carries configuration information of a direct path, the direct path may be configured according to the configuration information of the direct path, and data transmission of the direct path is resumed;
an RRC reconfiguration message sent by a serving base station is successfully applied, where the RRC reconfiguration message carries configuration information of a direct path, the direct path may be configured according to the configuration information of the direct path, and data transmission of the direct path is resumed;
an RRC reconfiguration complete message is sent to the serving base station, where the an RRC reconfiguration message corresponding to the RRC reconfiguration complete message carries configuration information of the direct path, the direct path may be configured according to acquired configuration information of the direct path, and data transmission through the direct path may be resumed; and
it is confirmed that an RRC reconfiguration complete message is successfully sent to the serving base station, where an RRC reconfiguration message corresponding to the RRC reconfiguration complete message carries configuration information of the direct path, and the direct path may be configured according to the acquired configuration information of the direct path, and data transmission through the direct path may be resumed.

The above “resume” may alternatively be interpreted as “restore” or “activate”.

In the embodiment, in a scenario that the terminal supports a multi path, if a radio link failure of a direct path occurs, the terminal can suspend data transmission of the direct path, and resume the data transmission after a radio link restoration. Thus, interruption of data reception and transmission of the terminal is reduced, and service continuity is maintained.

In some embodiments, in a case that the first path is the indirect path, the processing module 220 is used to suspend or stop, in a case that the first terminal detects that a first path of the multi path fails, data transmission through the first path includes any one of the following:
in a case that it is detected that a radio link failure between the first terminal and the second terminal occurs on the first path, the data transmission through the first path is stopped, where an interface between the first terminal and the second terminal may be a PC5 interface; and
in a case that indication information of the second terminal is received, the data transmission through the first path is suspended, where the indication information indicates that the second terminal satisfies a preset failure condition.

When the above situations occur, it indicates that data transmission through an indirect path fails, and it is required to suspend the data transmission through the indirect path. In the embodiment, in cases that it is detected that the indirect path fails, and no failure is detected in the direct path, the direct path of the first terminal normally works. Thus, no additional processing is required for transmission through the direct path, that is, the transmission of the direct path can still be continuously carried out.

In some embodiments, the preset failure condition includes at least one of the following:
a Uu radio link failure occurs on the second terminal;
an RRC connection failure of a Uu air interface radio resource control occurs on the second terminal, which includes three situations as follows: a failure of an RRC connection establishment process (for a case that the second terminal is in an RRC idle state), a failure of an RRC connection restoration process (for a case that the second terminal is in an RRC inactive state), and a rejection of an RRC connection (for a case that the second terminal is in an RRC idle state or an RRC inactive state); and
a serving cell change occurs on the second terminal, where the serving cell change includes handover (handover) and cell (re-)selection (cell (re-)selection). In a case that the second terminal is in an RRC connected state, the serving cell change may be handover. In a case that the second terminal is in a non-RRC connected state, such as an RRC idle state or an RRC inactive state, the serving cell change may be cell (re-)selection.

In some embodiments, the step that the data transmission through the first path is suspended includes at least one of the following:
indirect path transmission for at least one DRB is suspended, which includes: indirect path transmission for all or some of DRBs is suspended, paused or deactivated, where the DRB includes at least one of a data radio bearer of the indirect path (which is referred to as an Indirect DRB for short), and an indirect path part of a split data radio bearer (which is referred to as an Indirect part of a split DRB for short);
indirect path transmission for at least one SRB is suspended, which includes: indirect path transmission for all or some of SRBs is suspended, paused or deactivated, where the SRB includes at least one of a signaling radio bearer 1 of the indirect path (which is referred to as an Indirect SRB1 for short), a signaling radio bearer 2 of the indirect path (which is referred to as an Indirect SRB2 for short), an indirect path part of a split signaling radio bearer 1 (which is referred to as an Indirect part of a split SRB1 for short), and an indirect path part of a split signaling radio bearer 2 (which is referred to as an Indirect part of a split SRB2 for short); and
indirect path transmission for at least one PC5 Relay RLC channel is suspended, which includes: indirect path transmission for all or some of PC5 Relay RLC channels is suspended, paused or deactivated; and
a PC5 MAC entity corresponding to the indirect path and the second terminal is reset.

The above “suspend” may alternatively be interpreted as “suspend (suspend)” or “deactivate (deactivate)”.

In some embodiments, the step that the data transmission through the first path is stopped includes at least one of the following:
at least one sidelink SL-DRB corresponding to the indirect path and the second terminal is released;
at least one SL-SRB corresponding to the indirect path and the second terminal is released;
at least one PC5 relay RLC channel corresponding to the indirect path and the second terminal is released; and
a PC5 MAC entity corresponding to the indirect path and the second terminal is reset.

In the embodiment, in a scenario that the terminal supports a multi path, if a radio link failure of an indirect path occurs, the terminal can stop data transmission of the indirect path, and re-establish the indirect path and then resume the data transmission after a radio link restoration.

In some embodiments, the processing module 220 is further used to resume, in a case that a preset restoration condition is satisfied, the data transmission through the first path,
which includes at least one of the following:
indirect path transmission for at least one DRB is resumed, which includes: indirect path transmission for all or some of DRBs is resumed, restored or activated, where the DRB includes at least one of a data radio bearer of the indirect path (which is referred to as an Indirect DRB for short), and an indirect path part of a split data radio bearer (which is referred to as an Indirect part of a split DRB for short);
indirect path transmission for at least one SRB is resumed, which includes indirect path transmission for all or some of SRBs is resumed, restored or activated, where the SRB includes at least one of a signaling radio bearer 1 of the indirect path (which is referred to as an Indirect SRB1 for short), a signaling radio bearer 2 of the indirect path (which is referred to as an Indirect SRB2 for short), an indirect path part of a split signaling radio bearer 1 (which is referred to as an Indirect part of a split SRB1 for short), and an indirect path part of a split signaling radio bearer 2 (which is referred to as an Indirect part of a split SRB2 for short); and
indirect path transmission for at least one PC5 Relay RLC channel is resumed, which includes: indirect path transmission for all or some of PC5 Relay RLC channels is resumed, restored or activated.

In some embodiments, the DRB includes at least one of the following:
a data radio bearer of the indirect path; and
an indirect path part of a split data radio bearer.

In some embodiments, the SRB includes at least one of the following:
a signaling radio bearer 1 of the indirect path;
a signaling radio bearer 2 of the indirect path;
an indirect path part of a split signaling radio bearer 1; and
an indirect path part of a split signaling radio bearer 2.

In some embodiments, the restoration condition includes any one of the following:
an RRC reconfiguration message sent by a serving base station is received, where the RRC reconfiguration message carries configuration information of the first path, the indirect path may be configured according to the configuration information of the indirect path, and data transmission of the indirect path is resumed;
an RRC reconfiguration message sent by a serving base station is successfully applied, where the RRC reconfiguration message carries configuration information of the first path, the indirect path may be configured according to the configuration information of the indirect path, and data transmission of the indirect path is resumed;
an RRC reconfiguration complete message is sent to the serving base station, where the an RRC reconfiguration message corresponding to the RRC reconfiguration complete message carries configuration information of the first path, the indirect path may be configured according to acquired configuration information of the indirect path, and data transmission through the indirect path may be resumed; and
it is confirmed that an RRC reconfiguration complete message is successfully sent to the serving base station, where an RRC reconfiguration message corresponding to the RRC reconfiguration complete message carries configuration information of the first path, and the indirect path may be configured according to the acquired configuration information of the indirect path, and data transmission through the indirect path may be resumed.

The above “resume” may alternatively be interpreted as “restore” or “activate”.

In the embodiment, in a scenario that the terminal supports a multi path, if a radio link failure of an indirect path occurs, the terminal can suspend data transmission of the indirect path, and resume the data transmission after a radio link restoration. Thus, interruption of data reception and transmission of the terminal is reduced, and service continuity is maintained.

The data transmission apparatus in an embodiment of the disclosure may be an electronic device, such as an electronic device having an operating system, or a component in the electronic device, such as an integrated circuit or a chip. The electronic device may be a terminal or another device other than the terminal. Illustratively, the terminal may include but is not limited to the types of the terminal 11 listed above. Another device may be a server, a network attached storage (Network Attached Storage, NAS), etc., and is not specifically limited in an embodiment of the disclosure.

The data transmission apparatus provided in an embodiment of the disclosure can implement each process implemented by the method embodiment of FIG. 5, and the same technical effect can be achieved, which will not be repeated herein to avoid repetition.

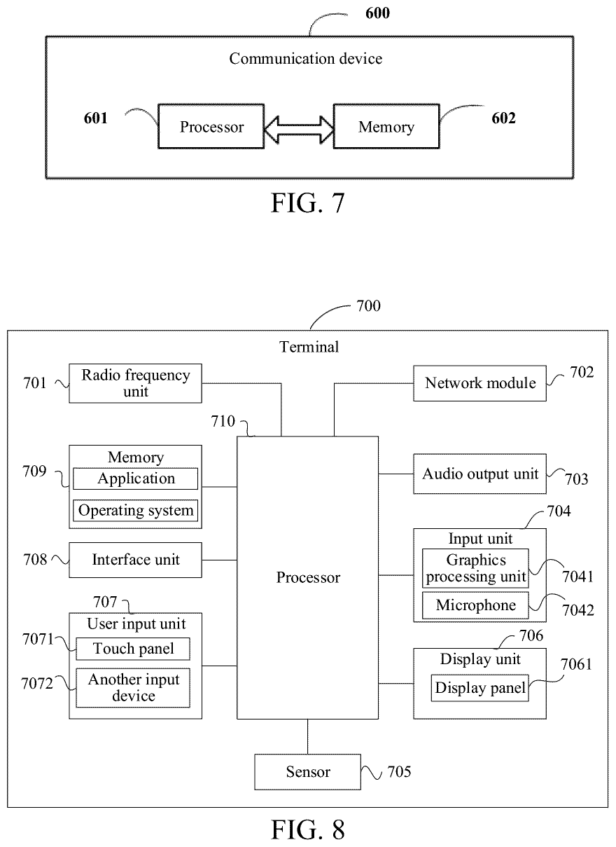

Optionally, as shown in FIG. 7, an embodiment of the disclosure further provides a communication device 600. The communication device includes a processor 601 and a memory 602. The memory 602 stores a program or an instruction that can be run on the processor 601. When the program or the instruction is executed by the processor 601, various steps of the above data transmission method embodiment can be implemented, and the same technical effect can be achieved, which will not be repeated herein to avoid repetition.

An embodiment of the disclosure further provides a terminal. The terminal includes a processor and a memory. The memory stores a program or an instruction capable of being run on the processor. When the program or the instruction is executed by the processor, the steps of the data transmission method as mentioned above are implemented.

An embodiment of the disclosure further provides a terminal. The terminal includes a processor and a communication interface. The communication interface is used to transmit data with a network-side device through a multi path. The multi path includes a direct path through which the first terminal is in directly communication with the network-side device and/or an indirect path through which the first terminal is in communication with the network-side device via a second terminal. The processor is configured to suspend or stop, in a case that the first terminal detects that the first path of the multi path fails, data transmission through the first path.

Each implementation process and implementation method in the above method embodiment can be applied to the terminal embodiment, and the same technical effect can be achieved. Specifically, FIG. 8 is a schematic diagram of a hardware structure of a terminal according to an embodiment of the disclosure.

The terminal 700 includes but is not limited to at least some components of a radio frequency unit 701, a network module 702, an audio output unit 703, an input unit 704, a sensor 705, a display unit 706, a user input unit 707, an interface unit 708, a memory 709 and a processor 710.

Those skilled in the art can understand that the terminal 700 may further include a power supply (such as a battery) for supplying power to the components. The power supply may be logically connected to the processor 710 by a power management system, such that functions, such as charging, discharging, and power consumption management are implemented by the power management system. The terminal structure shown in FIG. 8 constitutes no limitation on the terminal. The terminal may include more or fewer components than those shown in the figures, some component combinations, or different component arrangements, which will not be repeated herein.

It should be understood that in an embodiment of the disclosure, an input unit 704 may include a graphics processing unit (Graphics Processing Unit, GPU) 7041 and a microphone 7042. The graphics processing unit 7041 processes image data of a static picture or a video that is acquired by an image capture apparatus (such as a camera) in a video capture mode or an image capture mode. A display unit 706 may include a display panel 7061. The display panel 7061 may be configured by using a liquid crystal display, an organic light-emitting diode, etc. A user input unit 707 includes a touch panel 7071 and at least one of other input devices 7072. The touch panel 7071 is also referred to as a touch screen. The touch panel 7071 may include a touch detection apparatus and a touch controller. The other input devices 7072 may include but are not limited to a physical keyboard, a functional key (such as a volume control key or a switch key), a track ball, a mouse and a joystick, which will not be repeated herein.

In an embodiment of the disclosure, after receiving downlink data from a network-side device, the radio frequency unit 701 may transmit the downlink data to the processor 710 for processing. In addition, the radio frequency unit 701 may send uplink data to the network-side device. Generally, the radio frequency unit 701 includes but is not limited to an antenna, an amplifier, a transceiver, a coupler, a low noise amplifier, a duplexer, etc.

The memory 709 may be used to store a software program, an instruction and various types of data. The memory 709 may mainly include a first storage area for storing a program or an instruction and a second storage area for storing data. The first storage area may store an operating system, an application or an instruction required for at least one function (such as a sound playback function and an image playback function), etc. Moreover, the memory 709 may include a volatile memory or a non-volatile memory, or the memory 709 may include both a volatile memory and a non-volatile memory. The non-volatile memory may be a read-only memory (Read-Only Memory, ROM), a programmable read-only memory (Programmable ROM, PROM), an erasable programmable read-only memory (Erasable PROM, EPROM), an electrically erasable programmable read-only memory (Electrically EPROM, EEPROM), or a flash memory. The volatile memory may be a random access memory (Random Access Memory, RAM), a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDRSDRAM), an enhanced synchronous dynamic random access memory (Enhanced SDRAM, ESDRAM), a synch link dynamic random access memory (Synch link DRAM, SLDRAM), and a direct rambus random access memory (Direct Rambus RAM, DRRAM). The memory 709 in an embodiment of the disclosure includes but is not limited to these and any other suitable types of memories.

The processor 710 may include one or more processing units. The processor 710 integrates an application processor and a modem processor. The application processor mainly processes operations related to an operating system, a user interface, an application, etc. The modem processor mainly processes a radio communication signal, such as a baseband processor. It can be understood that the above modem processor may not be integrated into the processor 710.

In some embodiments, the processor 710 is used to transmit data with a network-side device through a multi path, where the multi path includes a direct path through which the first terminal is directly in communication with the network-side device and/or an indirect path through which the first terminal is in communication with the network-side device via a second terminal; and suspend or stop, in a case that it is detected that the first path of the multi path fails, data transmission through the first path.

In some embodiments, the multi path includes:
at least two indirect paths; or
at least one indirect path and at least one direct path.

In some embodiments, in a case that the first path is a direct path, the processor 710 is used to suspend or stop, in a case that it is detected that a first path of the multi path fails, data transmission through the first path, which includes:
the processor 710 is used to suspend, in a case that at least one of the following conditions is satisfied, the data transmission through the first path;
it is detected that a Uu radio link failure occurs on the direct path;
it is detected that a Uu beam failure occurs on the direct path; and
a direct path configuration failure occurs.

In some embodiments, the step that the data transmission through the first path is suspended includes at least one of the following:
direct path transmission for at least one data radio bearer DRB is suspended;
direct path transmission for at least one signaling radio bearer SRB is suspended;
direct path transmission for at least one Uu radio link control RLC channel is suspended; and
a medium access control MAC entity of the direct path is reset.

In some embodiments, the processor 710 is used to resume, in a case that a preset restoration condition is satisfied, the data transmission through the first path, which includes at least one of the following:
direct path transmission for the at least one DRB is resumed;
direct path transmission for the at least one SRB is resumed; and
direct path transmission for the at least one Uu RLC channel is resumed.

In some embodiments, the DRB includes at least one of the following:
the data radio bearer of the direct path; and
a direct path part of a split data radio bearer.

In some embodiments, the SRB includes at least one of the following:
a signaling radio bearer 1 of the direct path;
a signaling radio bearer 2 of the direct path;
a direct path part of a split signaling radio bearer 1; and
a direct path part of a split signaling radio bearer 2.

In some embodiments, in a case that the first path is the indirect path, the processor 710 is used to suspend or stop, in a case that it is detected that a first path of the multi path fails, data transmission through the first path, which includes any one of the following:
in a case that it is detected that a radio link failure between the first terminal and the second terminal occurs on the first path, the data transmission through the first path is stopped; and
in a case that indication information of the second terminal is received, the data transmission through the first path is suspended, where the indication information indicates that the second terminal satisfies a preset failure condition.

In some embodiments, the preset failure condition includes at least one of the following:
a Uu radio link failure occurs on the second terminal;
a Uu radio resource control RRC connection failure occurs on the second terminal; and
a serving cell change occurs on the second terminal.

In some embodiments, the step that the data transmission through the first path is suspended includes at least one of the following:
indirect path transmission for at least one DRB is suspended;
indirect path transmission for at least one SRB is suspended;
indirect path transmission for at least one PC5 relay RLC channel is suspended; and
a PC5 MAC entity corresponding to the indirect path and the second terminal is reset.

In some embodiments, the step that the data transmission through the first path is stopped includes at least one of the following:
at least one sidelink SL-DRB corresponding to the indirect path and the second terminal is released;
at least one SL-SRB corresponding to the indirect path and the second terminal is released;
at least one PC5 relay RLC channel corresponding to the indirect path and the second terminal is released; and
a PC5 MAC entity corresponding to the indirect path and the second terminal is reset.

In some embodiments, after the data transmission through the first path is suspended, the processor 710 is used to resume, in a case that a preset restoration condition is satisfied, the data transmission through the first path,
which includes at least one of the following:
indirect path transmission for the at least one DRB is resumed;
indirect path transmission for the at least one SRB is resumed; and
indirect path transmission for the at least one PC5 relay RLC channel is resumed.

In some embodiments, the DRB includes at least one of the following:
a data radio bearer of the indirect path; and
an indirect path part of a split data radio bearer.

In some embodiments, the SRB includes at least one of the following:
a signaling radio bearer 1 of the indirect path;
a signaling radio bearer 2 of the indirect path;
an indirect path part of a split signaling radio bearer 1; and
an indirect path part of a split signaling radio bearer 2.

In some embodiments, the restoration condition includes any one of the following:
an RRC reconfiguration message sent by a serving base station is received, where the RRC reconfiguration message carries configuration information of the first path;
the RRC reconfiguration message sent by the serving base station is successfully applied, where the RRC reconfiguration message carries the configuration information of the first path;
an RRC reconfiguration complete message is sent to the serving base station, where RRC reconfiguration message corresponding to the RRC reconfiguration complete message carries the configuration information of the first path; and
it is confirmed that the RRC reconfiguration complete message is successfully sent to the serving base station, where the RRC reconfiguration message corresponding to the RRC reconfiguration complete message carries the configuration information of the first path.

An embodiment of the disclosure further provides a readable storage medium. A program or an instruction is stored in the readable storage medium. When the program or the instruction is executed by a processor, each process of the above data transmission method embodiment can be implemented, and the same technical effect can be achieved, which will not be repeated herein to avoid repetition.

The processor is a processor in the terminal described in the above embodiment. The readable storage medium may be non-volatile or non-transitory. The readable storage medium includes a computer-readable storage medium, such as a computer read-only memory ROM, a random access memory RAM, a magnetic disk, and an optical disk.

An embodiment of the disclosure further provides a chip. The chip includes a processor and a communication interface. The communication interface is coupled to the processor. The processor is configured to run a program or an instruction to implement various processes of the above data transmission method embodiment, and the same technical effect can be achieved, which will not be repeated herein to avoid repetition.

It should be understood that the chip mentioned in an embodiment of the disclosure may alternatively be referred to as a system on a chip.

An embodiment of the disclosure further provides a computer program/program product. The computer program/program product is stored in a storage medium and executed by at least one processor to implement various processes of the above data transmission method embodiment, and the same technical effect can be achieved, which will not be repeated herein to avoid repetition.

An embodiment of the disclosure further provides a data transmission system. The system includes: a network-side device and a terminal. The terminal is used to execute the steps of the data transmission method as mentioned above.

In embodiments of the disclosure, a multi-path connection is established between the first terminal and the network-side device. In a case that it is detected that a first path of a multi path fails, the first terminal can suspend or stop data transmission through the first path such that the terminal can temporarily suspend the data transmission in a case of a radio link failure, and resume the data transmission after a radio link restoration. That is, a plurality of transmission paths are established, and in a case that some paths fail, the paths are paused or stopped. Thus, interruption of data reception and transmission of the terminal is reduced, and service continuity is maintained.

It should be noted that the terms “comprise”, “include” or their any other variations herein are intended to cover non-exclusive inclusions, such that a process, method, article or apparatus including a series of elements not only includes those elements, but also includes other elements that are not explicitly listed, or also includes inherent elements of such a process, method, article or apparatus. In a case of no more limitations, an element limited by phrases “comprising a . . . ” or “including a . . . ” does not exclude other same elements in a process, method, article or apparatus including the element. In addition, it should be noted that the scopes of the method and apparatus in implementations of the disclosure are not limited to execute functions in the sequence shown or discussed, but may also execute functions substantially simultaneously or in the reverse sequence of the functions involved. For example, the described method may be executed in an order different from that described, and various steps may be added, omitted or combined. In addition, features described with reference to some examples may also be combined in other examples.

Through the descriptions in the above implementations, those skilled in the art would clearly know that the methods according to the above embodiments may be achieved by software plus a necessary general-purpose hardware platform, and certainly may also be achieved by hardware, but in many cases, the former is a better implementation. Based on the understanding, the technical solution of the disclosure may be embodied in a form of a computer software product in essence or a part contributing to the prior art. The computer software product is stored in a storage medium (such as an ROM/RAM, a magnetic disk, and an optical disk), and includes several instructions for enabling a terminal (which may be a mobile phone, a computer, a server, an air conditioner, a network device, etc.) to execute the methods in all embodiments of the disclosure.

The embodiments of the disclosure are described above in combination with accompanying drawings. However, the disclosure is not limited to the above particular implementations. The above particular implementations are merely schematic and not limitative. Those of ordinary skill in the art can also make various variations under the teaching of the disclosure without departing from the spirit of the disclosure and the scope of protection of the claims. Such variations all fall within the scope of protection of the disclosure.

What is claimed is:

1. A data transmission method, comprising:
transmitting, by a first terminal, data with a network-side device through a multi path, wherein the multi path comprises a direct path through which the first terminal is in directly communication with the network-side device and/or an indirect path through which the first terminal is in communication with the network-side device via a second terminal; and
suspending, in a case that the first terminal detects that a first path of the multi path fails, data transmission through the first path.

2. The data transmission method according to claim 1, wherein the multi path comprises:
at least one indirect path and at least one direct path.

3. The data transmission method according to claim 1, wherein in a case that the first path is the direct path, the suspending, in a case that the first terminal detects that a first path of the multi path fails, data transmission through the first path comprises:
suspending, in a case that the first terminal determines that at least one of the following conditions is satisfied, the data transmission through the first path:
detecting that a Uu radio link failure occurs on the direct path;
detecting that a Uu beam failure occurs on the direct path; and
a direct path configuration failure occurs.

4. The data transmission method according to claim 3, wherein the suspending data transmission through the first path comprises at least one of the following:
suspending direct path transmission for at least one data radio bearer DRB;
suspending direct path transmission for at least one signaling radio bearer SRB;
suspending direct path transmission for at least one Uu radio link control RLC channel; and
resetting a medium access control MAC entity of the direct path.

5. The data transmission method according to claim 4, wherein in a case that a preset restoration condition is satisfied, the first terminal resumes the data transmission through the first path, which comprises at least one of the following:
the direct path transmission for the at least one DRB is resumed;
the direct path transmission for the at least one SRB is resumed; and
the direct path transmission for the at least one Uu RLC channel is resumed.

6. The data transmission method according to claim 1, wherein in a case that the first path is the indirect path, the suspending, in a case that the first terminal detects that a first path of the multi path fails, data transmission through the first path comprises:
suspending, in a case that the first terminal receives indication information of the second terminal, the data transmission through the first path, wherein the indication information indicates that the second terminal satisfies a preset failure condition.

7. The data transmission method according to claim 6, wherein the preset failure condition comprises at least one of the following:
a Uu radio link failure occurs on the second terminal;
a Uu radio resource control RRC connection failure occurs on the second terminal; and
a serving cell change occurs on the second terminal.

8. The data transmission method according to claim 6, wherein the suspending data transmission through the first path comprises at least one of the following:
suspending indirect path transmission for at least one DRB;
suspending indirect path transmission for at least one SRB;
resetting a PC5 MAC entity corresponding to the indirect path and the second terminal.

9. The data transmission method according to claim 8, wherein after the suspending data transmission through the first path, the method further comprises:
resuming, by the first terminal in a case that a preset restoration condition is satisfied, the data transmission through the first path; and
the resuming, by the first terminal, the data transmission through the first path comprises at least one of the following:
resuming the indirect path transmission for the at least one DRB;
resuming the indirect path transmission for the at least one SRB; and
resuming the indirect path transmission for the at least one PC5 relay RLC channel.

10. The data transmission method according to claim 8, wherein the DRB comprises at least one of the following:
a data radio bearer of the indirect path; and
an indirect path part of a split data radio bearer.

11. The data transmission method according to claim 8, wherein the SRB comprises at least one of the following:
a signaling radio bearer 1 of the indirect path;
a signaling radio bearer 2 of the indirect path;
an indirect path part of a split signaling radio bearer 1; and
an indirect path part of a split signaling radio bearer 2.

12. The data transmission method according to claim 9, wherein the restoration condition comprises any one of the following:
an RRC reconfiguration message sent by a serving base station is received, wherein the RRC reconfiguration message carries configuration information of the first path;
the RRC reconfiguration message sent by the serving base station is successfully applied, wherein the RRC reconfiguration message carries the configuration information of the first path;
an RRC reconfiguration complete message is sent to the serving base station, wherein RRC reconfiguration message corresponding to the RRC reconfiguration complete message carries the configuration information of the first path; and
it is confirmed that the RRC reconfiguration complete message is successfully sent to the serving base station, wherein the RRC reconfiguration message corresponding to the RRC reconfiguration complete message carries the configuration information of the first path.

13. A first terminal, comprising a processor and a memory, wherein the memory stores a program or an instruction, and when the program or the instruction is executed by the processor, the first terminal is caused to:
transmit data with a network-side device through a multi path, wherein the multi path comprises a direct path through which the first terminal is in directly communication with the network-side device and/or an indirect path through which the first terminal is in communication with the network-side device via a second terminal; and
suspend, in a case that the first terminal detects that a first path of the multi path fails, data transmission through the first path.

14. The first terminal according to claim 13, wherein the multi path comprises:
at least one indirect path and at least one direct path.

15. The first terminal according to claim 13, wherein when the program or the instruction is executed by the processor, the first terminal is caused to:
suspend, in a case that the first terminal receives indication information of the second terminal, the data transmission through the first path, wherein the indication information indicates that the second terminal satisfies a preset failure condition.

16. The first terminal according to claim 15, wherein when the program or the instruction is executed by the processor, the first terminal is caused to perform at least one of the following:
suspending indirect path transmission for at least one DRB;
suspending indirect path transmission for at least one SRB; or
resetting a PC5 MAC entity corresponding to the indirect path and the second terminal.

17. A non-transitory computer-readable storage medium, storing a program or an instruction, wherein when the program or the instruction is executed by a processor of a first terminal, the first terminal is caused to:
transmit data with a network-side device through a multi path, wherein the multi path comprises a direct path through which the first terminal is in directly communication with the network-side device and/or an indirect path through which the first terminal is in communication with the network-side device via a second terminal; and
suspend, in a case that the first terminal detects that a first path of the multi path fails, data transmission through the first path.

18. The non-transitory computer-readable storage medium according to claim 17, wherein the multi path comprises:
at least one indirect path and at least one direct path.

19. The non-transitory computer-readable storage medium according to claim 17, wherein when the program or the instruction is executed by a processor of a first terminal, the first terminal is caused to:
suspend, in a case that the first terminal receives indication information of the second terminal, the data transmission through the first path, wherein the indication information indicates that the second terminal satisfies a preset failure condition.

20. The non-transitory computer-readable storage medium according to claim 19, wherein when the program or the instruction is executed by a processor of a first terminal, the first terminal is caused to perform at least one of the following:
suspending indirect path transmission for at least one DRB;
suspending indirect path transmission for at least one SRB; or
resetting a PC5 MAC entity corresponding to the indirect path and the second terminal.
